(19) United States
(12) Patent Application Publication
(10) Pub. No.: US 2022/0300191 A1
(43) Pub. Date: Sep. 22, 2022

(54) CONTROL APPARATUS AND METHOD FOR READING DATA

(71) Applicant: FUJITSU LIMITED, Kawasaki-shi (JP)

(72) Inventor: Taketoshi Yoshida, Kunitachi (JP)

(73) Assignee: FUJITSU LIMITED, Kawasaki-shi (JP)

(21) Appl. No.: 17/541,323

(22) Filed: Dec. 3, 2021

(30) Foreign Application Priority Data
Mar. 17, 2021 (JP) 2021-043071

(51) Int. Cl. G06F 3/06

(52) U.S. Cl. CPC G06F 3/0655; G06F 3/0604; G06F 3/0676; G06F 3/0679; G06F 3/0682

(57) ABSTRACT

A control apparatus includes: a memory; and a processor coupled to the memory. The processor stores a first data and a second data in a storing region after reading each of the first data and the second data from a recording medium based on first information including information on respective recording positions of a plurality of data in the recording medium and respective read-times at which the plurality of data are read from the recording medium. The first data serves as a read-target of a first read-request to the recording medium, and the second data has co-occurrence relation to the first data. In a case where a second read-request to the recording medium is detected, the processor transmits the second data to a transmission source of the second read-request after reading the second data stored in the storing region. The second read-request regards the second data as a read-target.

### CROSS-REFERENCE TO RELATED APPLICATION

This application is based upon and claims the benefit of priority of the prior Japanese Patent application No. 2021-043071, filed on Mar. 17, 2021, the entire contents of which are incorporated herein by reference.

### FIELD

The embodiment discussed herein is related to a control apparatus and a method for reading data.

### BACKGROUND

Storage systems that store data, for example, object storage systems that handle objects, sometimes perform tiering control. The tiering control arranges, in accordance with frequency of access from applications to objects, for example, frequently accessed objects in a low latency tier and less frequently accessed objects in a high latency tier.

The low latency tier is, for example, a storage device including one or both of a magnetic disk device such as an HDD (Hard Disk Drive) and a semiconductor drive device such as an SSD (Solid State Drive), which have high accessibility (high speed) but have high cost (storage cost) per unit capacity.

The high latency tier is a storage device that uses a tape device accommodating a Physical Volume (PV) such as a magnetic tape cartridge, which has low accessibility (low speed) but has low cost (storage cost) per unit capacity. The PV is an example of a “tape volume” or a “portable recording medium”.

Hereinafter, for convenience, the low latency tier may be referred to as an “HDD tier” or an “HDD storage tier”, the high latency tier may be referred to as a “tape tier” or a “tape storage tier”, and the low latency tier and the high latency tier may be collectively referred to as a “storage tier”.

In the object storage system, for example, when receiving, from an application, a transfer-request for a less frequently accessed object arranged in the HDD tier, a control apparatus transfers the object from the HDD tier to the tape tier by the tiering control in response to the transfer-request.

Further, when receiving read-requests for objects from an application, the control apparatus performs a reading process that reads the objects from the storage tier in the order of receiving the read-requests to respond to the application.
[Patent Document 1] Japanese Laid-open Patent Publication No. 2020-119145
[Patent Document 2] Japanese Laid-open Patent Publication No. H8-329090

It is assumed that multiple objects relating to multiple read-requests are stored in a certain PV of the tape tier. In the PV, when the order of receiving the read-requests (reading order of the objects) is different from the order of storing the objects, the tapes of the PV is rewound by a drive device that performs access such as reading and writing of data to the PV in the tape tier.

In the rewinding, the drive device executes a location process that feeds (moves) the tape of the PV in a direction opposite to a forward direction by using a drive mechanism such as a motor so that the head for accessing the tape is positioned at the top of the object serving as a read-target.

When the location process occurs, as compared with a case where the order of receiving the read-requests matches the order of storing the objects, the processing performance (reading performance) of the reading process may be degraded, which may lead to an increase in time period (hereinafter also referred to as “period”) of reading, in other words, time period for responding to the read-request.

### SUMMARY

According to an aspect of the embodiments, a control apparatus may control access to a recording medium recording a plurality of data. The control apparatus may include: a memory; and a processor coupled to the memory. The processor may be configured to store a first data and a second data in a storing region after reading each of the first data and the second data from the recording medium based on first information including information on respective recording positions of the plurality of data in the recording medium and respective read-times at which the plurality of data are read from the recording medium. The first data may serve as a read-target of a first read-request to the recording medium. The second data may have co-occurrence relation to the first data. The processor may be configured to transmit, in a case where a second read-request to the recording medium is detected, the second data to a transmission source of the second read-request after reading the second data stored in the storing region. The second read-request may regard the second data as a read-target.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of a location process in an object storage system;

FIG. 2 is a block diagram illustrating a hardware (HW) configuration example of a system according to one embodiment;

FIG. 3 is a block diagram illustrating a HW configuration example of a computer;

FIG. 4 is a block diagram illustrating a functional configuration example of the system according to the one embodiment;

FIG. 5 is a diagram illustrating an example of a read-time database (DB);

FIG. 6 is a diagram illustrating an example of a tape object (OBJ) managing DB;

FIG. 7 is a diagram illustrating an example of the tape OBJ managing DB used for explaining a co-occurrence relation detecting process;

FIG. 8 is a diagram illustrating an example of relationships between OBJs and read-times;

FIG. 9 is a diagram illustrating an example of an OBJ list;

FIG. 10 is a diagram illustrating an exemplary ratio of duration of a consecutive reading to a skipped reading in a tape;

FIG. 11 is a flowchart for explaining an operation example of a read-time managing process and a transfer instructing process;

FIG. 12 is a sequence diagram illustrating an example of the read-time managing process;

FIG. 13 is a sequence diagram for explaining an example of the transfer instructing process and a writing process;

FIG. 14 is a flowchart for explaining an operation example of the writing process and a reading process; and

FIG. 15 is a sequence diagram for explaining an example of the reading process.

### DESCRIPTION OF EMBODIMENT(S)

Hereinafter, an embodiment of the present invention will now be described with reference to the drawings. However, the embodiment described below is merely illustrative, and there is no intention to exclude application of various modifications and techniques that are not explicitly described below. For example, the present embodiment can be variously modified and implemented without departing from the scope thereof. In the drawings used in the following embodiment, the same reference symbols denote the same or similar parts, unless otherwise specified.

### <1> One Embodiment

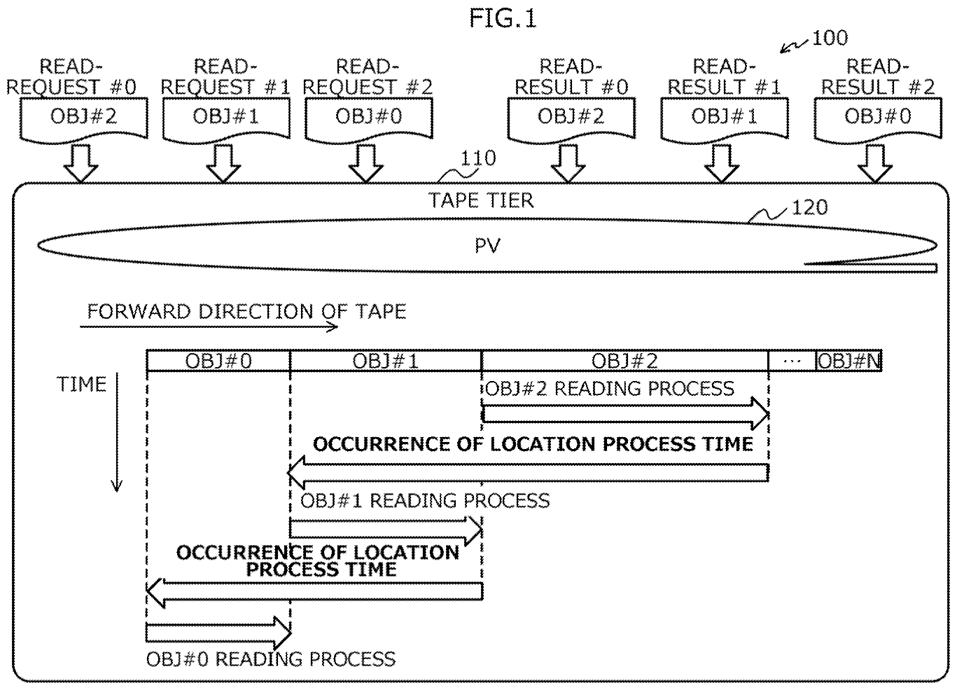

FIG. 1 is a diagram for explaining an example of a location process in an object storage system 100. As illustrated in FIG. 1, it is assumed that, in the object storage system 100, read-requests are issued for objects (hereinafter also referred to as “OBJs”) stored in a PV 120 included in a tape tier 110.

The example of FIG. 1 omits illustration of an HDD tier. For example, the tape tier 110 may receive the read-requests issued from a non-illustrated application via the HDD tier. The read-requests may be processed by a control apparatus that controls the tape tier 110 or by a control apparatus that controls both the HDD tier and the tape tier.

As illustrated in FIG. 1, it is assumed that, in the PV 120, OBJs #0, #1, #2, . . . and #N (where N is an integer of 1 or more) are stored in a forward direction of a tape. In response to receiving a read-request #0 for the OBJ #2, a read-request #1 for the OBJ #1, and a read-request #2 for the OBJ #0, the tape tier 110 executes respective reading processes for the OBJs #2, #1, and #0 serving as read-targets, in the order of receiving the read-requests from the PV 120. Then, the tape tier 110 responds with the read OBJs #2, #1, and #0 as read-results #0, #1, and #2, respectively.

As illustrated in FIG. 1, after the reading process for the OBJ #2 and before the reading process for the OBJ #1, the tape tier 110 performs the location process that moves the head in a rewind direction opposite to the forward direction of the tape for the PV 120 to position the head at the top of the OBJ #1. In addition, after the reading process for the OBJ #1 and before the reading process for the OBJ #0, the tape tier 110 performs the location process that moves the head in the rewind direction for the PV 120 to position the head at the top of the OBJ #0.

Meanwhile, there may be co-occurrence relation among the objects OBJ #2 to #0 serving as the read-targets of the multiple read-requests #0 to #2. The “co-occurrence relation” is a relationship in which reading of one (first) object causes reading of another (second) object. In such a case, it can be regarded that the one object has the co-occurrence relation to another object. The multiple objects having the co-occurrence relation may be mutually or unilaterally related, for example, may be associated with each other, or may be appropriately or sequentially read in a predetermined process in the application. In the following description, the “co-occurrence relation” is assumed to include a relationship regarding access order (e.g., reading order) of objects having the co-occurrence relation, such as the order of receiving the read-requests.

The multiple read-requests that regard multiple objects having the co-occurrence relation as the read-targets may be repeatedly issued in the same reading order, in other words, may have repeatability. For this reason, when the multiple objects having the co-occurrence relation (including a predetermined reading order) are not recorded on the PV 120 along with the forward direction of the tape, the location process occurs each time the multiple read-requests are received. As a result, reading performance may be degraded, which may lead to an increase in time period of reading.

For example, the object storage system 100 sometimes handles a large number of objects each having a size of tens of kilobytes to hundreds of megabytes, and may process read-requests or write-requests for multiple objects in the unit of hundreds of gigabytes to several terabytes. Accordingly, as the number of objects to be handled increases, the number of objects having the co-occurrence relation increases and the order of storing the objects in the PV 120 becomes less likely to conform to the forward direction of the tape, which results in a higher possibility that the time period of reading increases due to the location processes.

Therefore, in one embodiment, description will be made in relation to a method for suppressing an increase in the time period for reading the multiple objects stored in the PV.

<1-1> Configuration Example of Object Storage System:

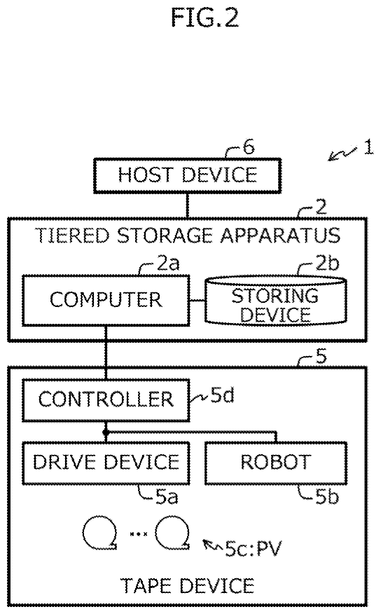

Hereinafter, an object storage system 1 (see FIG. 2) as an example of the one embodiment will be described. The object storage system 1 may be a tiered storage system that performs tiering control, and is an example of a storage system or an information processing system. Hereinafter, the object storage system 1 may be simply referred to as “system 1”.

(Hardware (HW) Configuration Example)

First, a HW configuration example of the system 1 according to the one embodiment will be described. FIG. 2 is a block diagram illustrating the HW configuration example of the system 1 according to the one embodiment. As illustrated in FIG. 2, the system 1 may illustratively include, as the HW configuration, a tiered storage apparatus 2, a tape device 5, and a host device 6.

The tiered storage apparatus 2 may illustratively include one or more computers 2a and one or more storing devices 2b. In the example of FIG. 2, the tiered storage apparatus 2 includes one computer 2a, but the tiered storage apparatus 2 is not limited to this configuration and may alternatively include multiple computers 2a as a redundant configuration.

The computer 2a is an example of a control apparatus or an information processing device, and performs various types of control relating to an HDD tier and a tape tier in the tiered storage apparatus 2. In the one embodiment, the computer 2a controls operations (processes) in both the HDD tier and the tape tier, but the computer 2a is not limited to this configuration. For example, the tiered storage apparatus 2 may include a computer 2a that controls operations (processes) in the HDD tier and another computer 2a that controls operations (processes) in the tape tier. In this case, the HDD tier and the tape tier may be “storage devices” separate from each other, and may realize the tiered storage apparatus 2 by, for example, cooperative operation of the respective computers 2a of the HDD tier and the tape tier.

The storing device 2b is an example of a storing device for realizing the HDD tier, and may include, for example, one or both of one or more magnetic disk devices such as HDDs and one or more semiconductor drive devices such as SSDs.

The tape device 5 is an example of a storing device for realizing the tape tier. The tape device 5 is connected to the tiered storage apparatus 2, and may illustratively include a drive device 5a, a robot 5b, and a controller 5d. The tape device 5 may include multiple drive devices 5a and/or multiple robots 5b.

The drive device 5a is an example of a medium processing device that performs access such as recording and reproducing of data to and from PVs 5c serving as an example of portable recording media, and is also an example of an access unit that accesses the PVs 5c. The robot 5b is an example of a transporting device that performs, for example, pick-up, transfer, and insertion into the driving device 5a of a medium cartridge of the PVs 5c. The PVs 5c are an example of multiple portable recording media that record data of multiple objects. The PVs 5c may be, for example, magnetic tapes such Linear Tape Open (LTO) cartridges that record data in units of blocks (BKs).

The controller 5d performs various types of control in the tape device 5. For example, the controller 5d may control the operation of the drive device 5a and the robot 5b in response to instructions (e.g., commands) received from the tiered storage apparatus 2, and may transmit responses to the commands to the tiered storage apparatus 2.

The host device 6 is an example of a processing device or an upper device that accesses to the HDD tier or the tape tier in the tiered storage apparatus 2. The host device 6 may be, for example, a Personal Computer (PC), a server, or a mainframe.

The tiered storage apparatus 2 and the tape device 5 may be, for example, communicably connected to each other through a network such as a Storage Area Network (SAN) via a Fibre Channel (FC) cable or the like. The tiered storage apparatus 2 and the host device 6 may be, for example, communicably connected to each other through a network such as a Local Area Network (LAN).

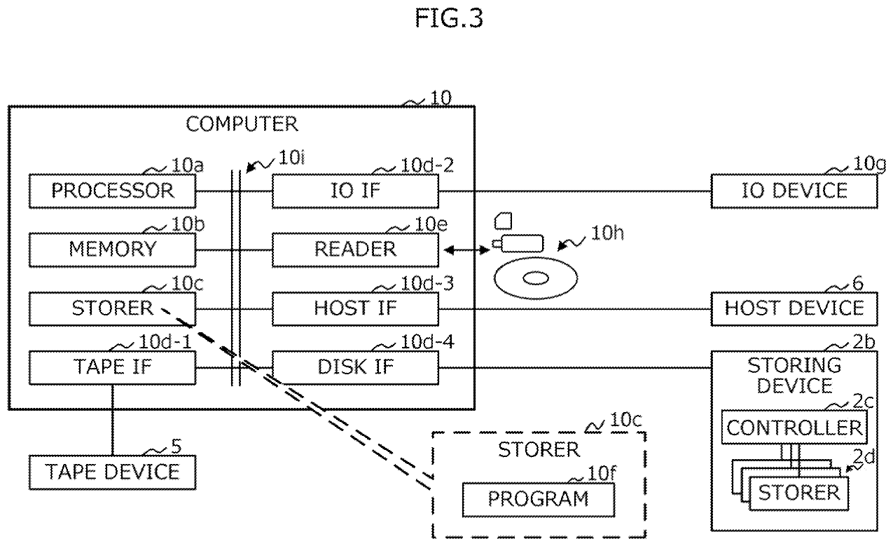

FIG. 3 is a block diagram illustrating a HW configuration example of a computer 10. The computer 10 is an example of the computer 2a illustrated in FIG. 2.

As illustrated in FIG. 3, the computer 10 may illustratively include a processor 10a, a memory 10b, a storer 10c, and a reader 10e. Further, for example, the computer 10 may include, as interfaces (IFs), a tape IF 10d-1, an input/output (IC) IF 10d-2, a host IF 10d-3, and a disk IF 10d-4.

The processor 10a is an example of an arithmetic processing device that performs various types of control and calculations. The processor 10a may be communicably connected to each of the blocks 10b-10e via a bus 10i. The processor 10a may be any one of integrated circuits (ICs) such as Central Processing Units (CPUs), Micro Processing Units (MPUs), Digital Signal Processors (DSPs), Application Specific Integrated Circuits (ASICs), and Programmable Logic Devices (PLDs) (e.g., Field Programmable Gate Arrays (FPGAs)), or combinations of two or more of these ICs.

The memory 10b is an example of a HW that stores various data and programs. The memory 10b may be a volatile memory, for example, a RAM such as a Dynamic Random Access Memory (DRAM).

The storer 10c is an example of a HW that stores various data, programs, and the likes. For example, the storer 10c may be used as a secondary storing device of the computer 10. The storer 10c may store an OS (Operating System), a program such as firmware or an application, and various types of data. Examples of the storer 10c may be various storing devices including a magnetic disk device such as an HDD, a semiconductor drive device such as an SSD, and a nonvolatile memory. The non-volatile memory may be, for example, a flash memory, a Storage Class Memory (SCM), a Persistent Memory (PM), a Read Only Memory (ROM), and the like. The storer 10c may store a program 10f that implements all or a part of various functions of the computer 10.

The tape IF 10d-1, the IO IF 10d-2, the host IF 10d-3, and the disk IF 10d-4 are examples of communication IFs that control connection and communication to the tape device 5, the IC device 10g, the host device 6, and the storing device 2b, respectively. The IC device 10g may include, for example, one or both of an input unit such as a mouse, a keyboard, a touch panel, and operation buttons, and an output unit such as a display and a printer.

Incidentally, the computer 10 may include a communication IF that controls connection and communication to a management terminal of an administrator, and may download, by using this communication IF, the program 10f from a non-illustrated network.

The reader 10e is an example of a reader that reads data and programs recorded on a recording medium 10h to output data and programs to the processor 10a. The reader 10e may include a connection terminal or a device to which the recording medium 10h can be connected or inserted. The reader 10e may be, for example, an adapter conforming to a Universal Serial Bus (USB) or the like, a drive device that accesses a recording disk, a card reader that accesses a flash memory such as an SD card, etc. The program 10f may be stored in the recording medium 10h.

The recording medium 10h may be, for example, a non-transitory computer-readable recording medium such as a magnetic/optical disk or a flash memory. Examples of the magnetic/optical disk may be a flexible disk, a Compact Disc (CD), a Digital Versatile Disc (DVD), a Blu-ray disk, a Holographic Versatile Disc (HVD), and the like. An example of the flash memory may be a semiconductor memory such as a USB memory or an SD card.

The HW configuration of the computer 10 described above is merely illustrative. Accordingly, the computer 10 may appropriately undergo an increase or a decrease (e.g., addition or deletion of arbitrary blocks), division, integration in an arbitrary combination of the HWs, addition or omission of the bus, and the like.

As illustrated in FIG. 3, the storing device 2b may illustratively include the controller 2c and multiple storers 2d. The controller 2c may perform various types of control relating to access to the multiple storers 2d. The storers 2d may have a HW configuration similar to that of the storer 10c.

One or both of the controller 2c and the controller 5d illustrated in FIG. 2 may include a HW configuration such as a processor, a memory, and a storer, and at least part of them may be implemented by an integrated circuit.

(Functional Configuration Example)

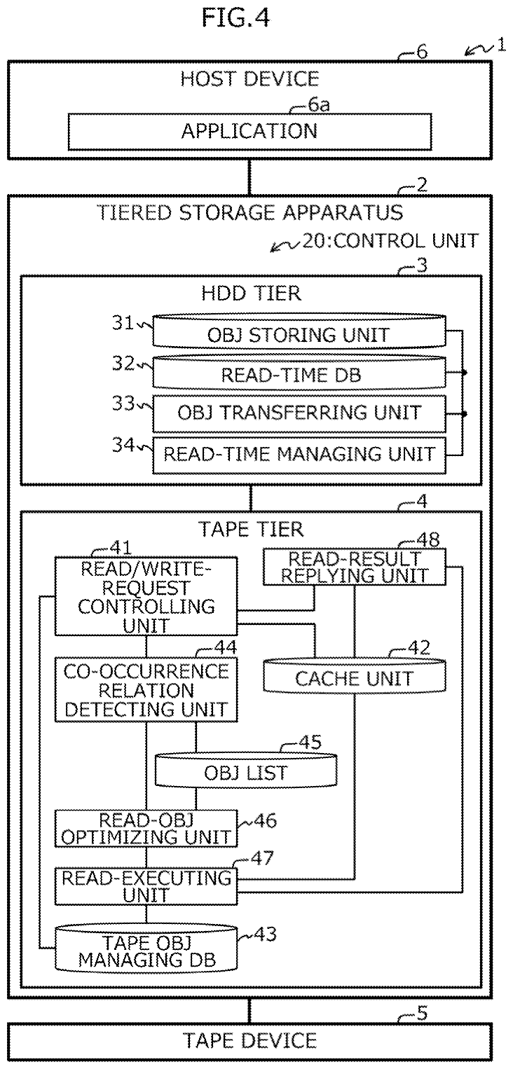

Next, description will now be made in relation to an example of a functional configuration (software (SW) configuration) of the system 1 according to the one embodiment. FIG. 4 is a block diagram illustrating a functional configuration example of the system 1 according to the one embodiment.

In the system 1 illustrated in FIG. 4, the host device 6 may execute a predetermined application (hereinafter also referred to as “APP”) 6a that accesses the tiered storage apparatus 2.

For example, the APP 6a may transmit a read-request or a write-request for an object (hereinafter also referred to as “OBJ”) to the tiered storage apparatus 2, and may receive a read-result or a write-result from the tiered storage apparatus 2. Further, to the tiered storage apparatus 2, the APP 6a may transmit a tier move request (transfer-request) for moving the OBJ stored in the HDD tier 3 to the tape tier 4.

The read-request may include, for example, identification information for identifying the OBJ of the read-target. The read-result may include the OBJ designated by the read-request. For example, the APP 6a according to the one embodiment is assumed to transmit multiple read-requests which target multiple OBJs having the co-occurrence relation to each other to the tiered storage apparatus 2. The transfer-request may include, for example, identification information for identifying the OBJ of the transfer-target.

The tiered storage apparatus 2 is an example of a control apparatus that controls access to a recording medium recording a plurality of data, and performs various types of control on the HDD tier 3 or the tape tier 4 in response to receiving the read-request, the write-request, or the transfer-request from the host device 6.

As illustrated in FIG. 4, the tiered storage apparatus 2 may include, as functional configurations, the HDD tier 3 and the tape tier 4. The HDD tier 3 and the tape tier 4 are examples of functions of a control unit 20 realized by the computer 2a of the tiered storage apparatus 2.

(Description of HDD Tier 3)

The HDD tier 3 is an example of a low latency tier, for example, a storage device that uses a storing device such as an HDD or an SSD, and may include, as illustrated in FIG. 4, an OBJ storing unit 31, a read-time DB 32, an OBJ transferring unit 33, and a read-time managing unit 34.

The OBJ storing unit 31 is an example of a storing device having an access speed higher than an access speed of the PVs 5c, and stores the OBJs accessed on the HDD tier 3. For example, the OBJ storing unit 31 may store data such as OBJs to be written into the HDD tier 3 by the write-requests. The OBJ storing unit 31 may be implemented by, for example, at least a part of a storing region of the storing device 2b illustrated in FIG. 2.

For example, in the system 1, the HDD tier 3 serves as a default storing destination of the OBJs to be written into the tiered storage apparatus 2. Thus, the OBJs written into the OBJ storing unit 31 in response to the write-requests are read and written in the OBJ storing unit 31 of the HDD tier 3 until the OBJs are transferred to the tape tier 4 in response to the transfer-requests of the OBJs.

The read-time DB 32 is a DB that manages read-times of the OBJs in the HDD tier 3. The read-time may be, for example, the time (hereinafter also referred to as “time point”) at which the read-request received from the APP 6a is detected or generated (occurred) (e.g., the time at which the read-request is transmitted from the APP 6a), the time at which the read-request is received, or the time at which the OBJ is read from the OBJ storing unit 31. Hereinafter, the read-time is assumed to be the time at which the read-request is transmitted from the APP 6a.

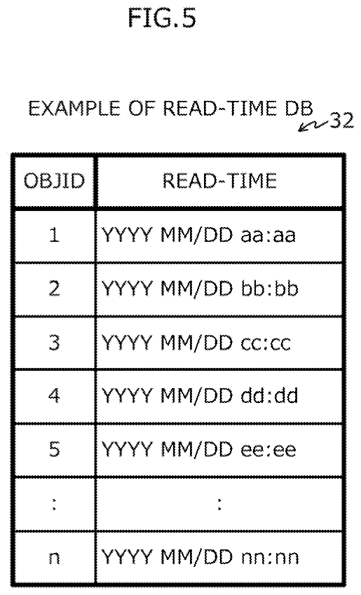

FIG. 5 is a diagram illustrating an example of the read-time DB 32. As illustrated in FIG. 5, the read-time DB 32 may illustratively include items such as “OBJID” (OBJ Identifier) as an example of the identification information of the OBJs and the “read-time”. The read-time DB 32 may record, for example, the latest (e.g., one) read-time or multiple recent read-times for each of the OBJs identified by the OBJIDs. Further, the read-time DB 32 may store information other than the read-time among the metadata relating to the OBJs, such as the data sizes of the OBJs.

The OBJ transferring unit 33 performs a transferring process that transfers (moves) information on the OBJ of the transfer-target from the HDD tier 3 to the tape tier 4 in response to the transfer-request received from the APP 6a for transfer from the HDD tier 3 to the tape tier 4. The information on the OBJ of the transfer-target may include the OBJ of the transfer-target designated by the transfer-request and the metadata relating to the OBJ.

For example, in the transferring process, the OBJ transferring unit 33 may transmit the information on the OBJ of the transfer-target to a read/write-request controlling unit 41 of the tape tier 4. Further, in the transferring process, the OBJ transferring unit 33 may delete the OBJ among the information on the OBJ of the transfer-target from the OBJ storing unit 31, and may delete the entry of the read-time of the OBJ from the read-time DB 32. The term “delete” may include managing the storing region of the data to be releasable.

The read-time managing unit 34 manages the read-times of the OBJs on the basis of the read-time DB 32. For example, when acquiring the read-times of the OBJs, the read-time managing unit 34 may store the read-times of the acquired OBJs in the read-time DB 32 in association with the OBJs.

(Description of Tape Tier 4)

The tape tier 4 is an example of a high latency tier, for example, a storage device that uses the PVs 5c such as magnetic disk cartridges. As illustrated in FIG. 4, the tape tier 4 may illustratively include the read/write-request controlling unit 41, a cache unit 42, a tape OBJ managing DB 43, a co-occurrence relation detecting unit 44, a read-OBJ optimizing unit 46, a read-executing unit 47, and a read-result replying unit 48.

The read/write-request controlling unit 41 performs various types of control relating to the read-request or the write-request received from the APP 6a for the OBJ in the tape tier 4. Hereinafter, description will be made in relation to a case of receiving, from the APP 6a, multiple (first) read-requests that regard multiple different OBJs in the tape tier 4 as the read-targets.

For example, the read/write-request controlling unit 41 may record, on the tape OBJ managing DB 43, the times at which the multiple read-requests received from the APP 6a are generated (detected), and may output, to the co-occurrence relation detecting unit 44 and the read-result replying unit 48, the OBJs of the read-targets designated by the multiple read-requests as arguments. The OBJ of the read-target (read-target OBJ) is an example of a first data serving as the read-target of a first read-request to the PVs 5c.

Further, for example, when the read-target OBJ is stored in the cache unit 42, the read/write-request controlling unit 41 may cause the read-result replying unit 48 to respond (reply) with the read-target OBJ serving as the read-result from the cache unit 42 to the transmission source of the read-request, for example, the APP 6a.

Furthermore, for example, when the read-target OBJ is stored in the cache unit 42, the read/write-request controlling unit 41 may output, to the co-occurrence relation detecting unit 44, the OBJs other than the read-target OBJ stored in the cache unit 42 among the multiple read-target OBJs. In other words, the read/write-request controlling unit 41 may exclude the read-target OBJ stored in the cache unit 42 from the arguments to be outputted to the co-occurrence relation detecting unit 44.

The cache unit 42 is an example of a storing region that stores the data of the OBJs, and for example, stores the OBJs read from the PVs 5c of the tape device 5 by the read-executing unit 47. The cache unit 42 may be realized by, for example, a storing region included in at least one of the memory 10b and the storer 10c (see FIGS. 2 and 3) of the computer 2a, and the storing device 2b.

The tape OBJ managing DB 43 is, for example, a database that manages storing positions and the read-times of the OBJs in the tape device 5. The tape OBJ managing DB 43 is an example of first information including information on the respective recording positions of the multiple data in the PVs 5c and the respective read-times at which the multiple data are read from the PVs 5c.

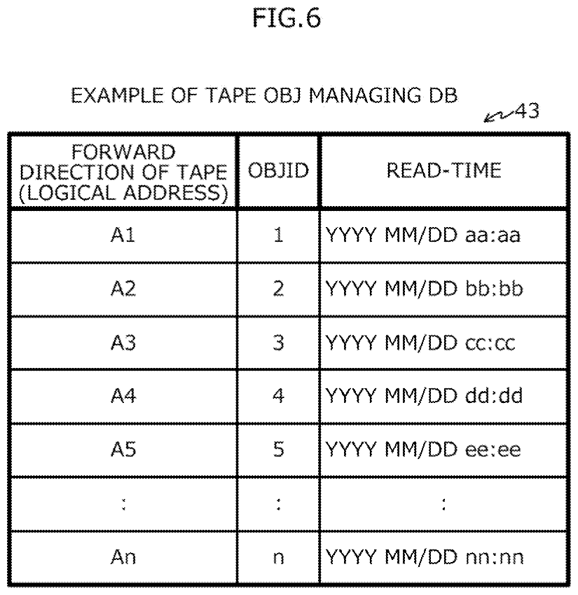

FIG. 6 is a diagram illustrating an example of the tape OBJ managing DB 43. As illustrated in FIG. 6, the tape OBJ managing DB 43 may illustratively include items such as “tape forward direction” in PVs 5c, “OBJID”, and “read-time”. The “tape forward direction” is an example of information indicating the storing locations of the OBJs in the PVs 5c, and may be, for example, logical addresses at which the OBJs are stored. The tape OBJ managing DB 43 may store information other than the read-times among the metadata relating to the OBJs, such as data sizes of the OBJs.

The tape OBJ managing DB 43 may store, for example, storing order (storing positions) in the PVs 5c in association with the read-times for all of the OBJs stored in the PVs 5c. The tape OBJ managing DB 43 may be generated and managed for each PV 5c, or may be generated and managed collectively for multiple PVs 5c. In the latter case, the “tape forward direction” may include information capable of identifying the PVs 5c.

As one of the timings at which the OBJs are stored in the tape tier 4, the one embodiment assumes the transferring process executed by the OBJ transferring unit 33 based on the transfer-request for the OBJ to be transferred from the HDD tier 3 to the tape tier 4. When the transferring process is performed, on the tape OBJ managing DB 43 related to the PVs 5c as the transfer destination, the OBJID and the read-time (in the HDD tier 3) read from the read-time DB 32 are recorded in association with the tape forward direction of the PVs 5c (in the order of the logical addresses).

As such, for example, when the transfer-requests for multiple data to be transferred from the OBJ storing unit 31 to the PVs 5c are generated (detected), the OBJ transferring unit 33 and the read/write-request controlling unit 41 store the multiple data in the PVs 5c. Further, the OBJ transferring unit 33 and the read/write-request controlling unit 41 record, on the tape OBJ managing DB 43, the respective read-times of the multiple data in the OBJ storing unit 31, which are stored in the read-time DB 32, as the initial values of the respective read-times of the multiple data in the PVs 5c.

The read/write-request controlling unit 41 may update the read-times of the read-target OBJs in the tape OBJ managing DB 43, at a predetermined timing, for example, after execution of the reading process in the tape tier 4.

The co-occurrence relation detecting unit 44 detects the co-occurrence relation of the read-target OBJs designated by the read-requests. For example, if there is a tendency that a reading of a certain OBJ accompanies another reading(s) of one or more OBJs having the read-time close to the (recent) read-time of the certain OBJ, the co-occurrence relation detecting unit 44 may detect the one or more OBJs to be the OBJs having the co-occurrence relation to the certain OBJ.

The OBJs having the co-occurrence relation to the read-target OBJ are, for example, the OBJs whose read-times are in the same time band as that of the read-time of the read-target OBJ in the tape OBJ managing DB 43. The “same time band” may be, for example, within a range from a predetermined time length before to after the read-time (reference time) of the OBJ of interest (reference), in other words, within a period of time between the predetermined time length before the reference time and the predetermined time length after the reference time. The predetermined time length may be, for example, a few seconds to a few hours, exemplarily several minutes or so, but is not limited to these examples.

For example, in the tape OBJ managing DB 43, the co-occurrence relation detecting unit 44 may extract the OBJs read in the same time band as that of the read-time of the read-target OBJ from the tape OBJ managing DB 43, and may generate an OBJ list 45. Incidentally, instead of generating the OBJ list 45, the co-occurrence relation detecting unit 44 may add, to the OBJs themselves or the tape OBJ managing DB 43, information (e.g., a flag) that can identify the OBJs having the co-occurrence relation.

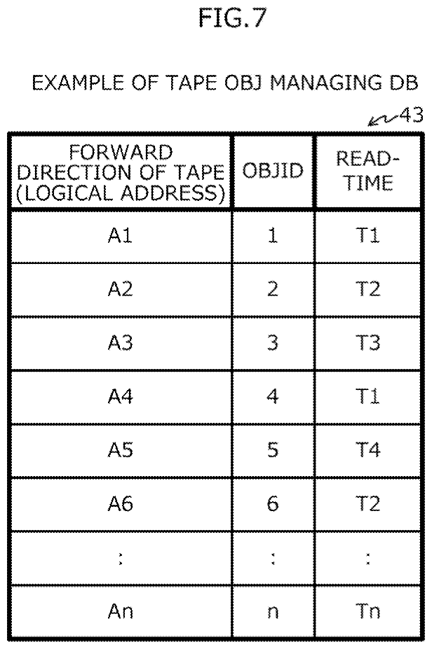

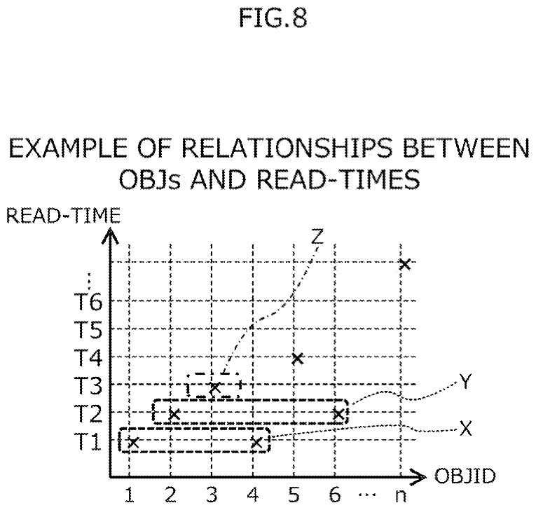

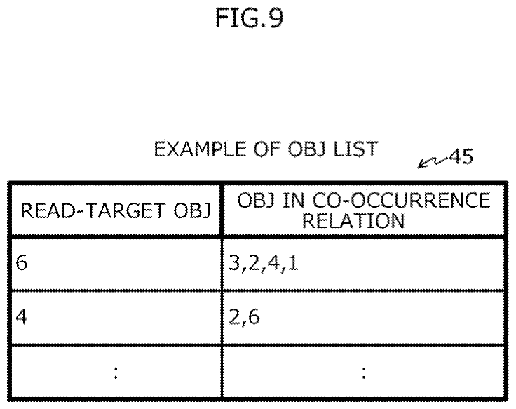

Hereinafter, with reference to FIGS. 7 to 9, description will be made in relation to an example of the co-occurrence relation detecting process executed by the co-occurrence relation detecting unit 44. FIG. 7 is a diagram illustrating an example of the tape OBJ managing DB 43 used for explaining the co-occurrence relation detecting process, FIG. 8 is a diagram illustrating an example of the relationships between the OBJs and the read-times, and FIG. 9 is a diagram illustrating an example of the OBJ list 45.

For example, in the following description, “x” represents a time difference or error (predetermined time length) for determining that multiple OBJs have the co-occurrence relation. In FIG. 7, for example, it is assumed that each of the time differences between T1 and T2, T2 and T3, or T3 and T4 of the read-times is equal to or less than x. The read-times T1 to Tn may each have a predetermined time width.

In the system 1 according to the one embodiment, for example, several to several hundred or more read-requests may be issued per second (in the frequency) for the OBJs from the APP 6a. Meanwhile, the time period of the reading process for reading the OBJs from the tape device 5 in the tape tier 4 is, for example, about 4 s/GB to 5 s/GB per OBJ.

Hence, in the system 1, during the execution of the reading process for a single read-target OBJ in the tape tier 4, for example, around several dozen read-requests may be generated. The one embodiment may judge one or more second OBJs which are the targets of the read-requests generated within the time period of the reading process for the first OBJ, in other words, within the time difference “±x” to be the OBJs having the co-occurrence relation to the first OBJ.

Here, the read-requests for the OBJIDs “6” and “1” (“OBJ6” and “OBJ1”) are assumed to be generated. For each of the OBJ6 and OBJ1 as the read-targets, the co-occurrence relation detecting unit 44 extracts, from the tape OBJ managing DB 43, the OBJs whose time differences in the read-times are in a relationship of “±x”.

For example, by referring to the tape OBJ managing DB 43, the co-occurrence relation detecting unit 44 extracts OBJ3, OBJ2, OBJ4, and OBJ1 whose read-times are in the relationship that the time difference is “±x” from the read-time T2 of OBJ6. As indicated by a symbol X in FIG. 8, each of the OBJ1 and the OBJ4 is the OBJ whose read-time T1 is in the relationship that the time difference from the read-time T2 of the OBJ6 is “−x”. As indicated by a symbol Y in FIG. 8, the OBJ2 is the OBJ whose read-time T2 is in the relationship that the time difference from the read-time T2 of the OBJ6 is “±0”. As indicated by a symbol Z in FIG. 8, the OBJ3 is the OBJ whose read-time T3 is in the relationship that the time difference from the read-time T2 of the OBJ6 is “+x”.

In addition, for example, by referring to the tape OBJ managing DB 43, the co-occurrence relation detecting unit 44 extracts OBJ4, OBJ2, and OBJ6 whose read-times are in the relationship that the time difference from the read-time T1 of the OBJ1 is “±x”. As indicated by the symbol Y in FIG. 8, each of the OBJ2 and the OBJ6 are the OBJ whose read-time T2 is in the relationship that the time difference from the read-time T1 of the OBJ1 is “+x”. As indicated by the symbol X in FIG. 8, the OBJ4 is the OBJ whose read-time T1 is in the relationship that the time difference from the read-time T1 of the OBJ1 is “±0”.

For example, as illustrated in FIG. 9, the co-occurrence relation detecting unit 44 may generate the OBJ list 45 in which the read-target OBJs are associated with the OBJs having the co-occurrence relation to the read-target OBJs. In the OBJ list 45 illustrated in FIG. 9, the first entry is a list of the OBJs having the co-occurrence relation to the OBJ6 of the read-target, and the second entry is a list of the OBJs having the co-occurrence relation to the OBJ1 of the read-target.

The read-OBJ optimizing unit 46 acquires the OBJs excluding the redundancy from the OBJ list 45 extracted by the co-occurrence relation detecting unit 44.

For example, regarding the OBJ6 and the OBJ1 serving as the read-targets, the read-OBJ optimizing unit 46 may acquire a list of OBJIDs “3, 2, 4, 1, 6” excluding the overlapping OBJIDs from OBJIDs “3, 2, 4, 1, 4, 2, 6” obtained by integrating the OBJs having the co-occurrence relation in the OBJ list 45.

The read-executing unit 47 rearranges the list of the OBJs “3, 2, 4, 1, 6” from which the redundancy has been excluded by the read-OBJ optimizing unit 46, in the recording order on the tapes of the PVs 5c, in other words, in the ascending order of the logical addresses, on the basis of the tape OBJ managing DB 43. For example, the read-executing unit 47 may sort the list of the OBJs “3, 2, 4, 1, 6” excluding the redundancy into “1, 2, 3, 4, 6” based on the tape forward direction illustrated in FIG. 7.

Then, the read-executing unit 47 reads the OBJs from the PVs 5c in the order of the rearranged list, stores the read OBJs in the cache unit 42, and instructs the read-result replying unit 48 to respond with the read-target OBJs among the read OBJs to the APP 6a.

At this time, the read-executing unit 47 may restrict the OBJs which are to be read from the PVs 5c in the rearranged lists to the OBJs located within a range having the multiple read-target OBJs as a head point and a tail point on the tape of the PVs 5c.

For example, when the read-target OBJs are the OBJ1 and the OBJ6, the read-executing unit 47 may restrict the OBJs which are to be read from the PVs 5c to the OBJ1 to the OBJ6, in other words, the OBJs recorded within the range of the logical addresses A1 to A6 (see FIG. 7).

Hereinafter, for convenience, among the multiple read-target OBJs, the OBJ1 having the smallest logical address may be referred to as a “head point OBJ” and the OBJ6 having the largest logical address may be referred to as a “tail point OBJ.”

As described above, the read-executing unit 47 sets, as a read-range, the range having end points defined by the head point OBJ and the tail point OBJ in the forward direction of the tapes of the PVs 5c.

As an example, when the rearranged list includes an OBJ having a logical address smaller than that of the head point OBJ1 or an OBJ having a logical address larger than that of the tail point OBJ6, the read-executing unit 47 may suppress reading the OBJ from the PVs 5c.

Accordingly, even those having the co-occurrence relation to the read-target OBJ, the OBJs stored outside the read-range are suppressed from being read from the PVs 5c, which can suppress an increase in the time period of reading.

As described above, the co-occurrence relation detecting unit 44 and the read-executing unit 47 store the read-target data (OBJ) and the second data (OBJ) having the co-occurrence relation to the read-target data in the cache unit 42 after reading those data from the PVs 5c based on the tape OBJ managing DB 43. The second data is, for example, the OBJ to be read from the PVs 5c to the cache unit 42 by the read-executing unit 47, among the OBJs having the co-occurrence relation to the read-target OBJ.

Accordingly, the OBJs having the co-occurrence relation to the read-target OBJ can be speculatively read to the cache unit 42, and thus, in the occurrence (detection) of the read-request that regards the OBJ having the co-occurrence relation to the read-target, it is possible to respond with the OBJs that have been read to the cache unit 42. That is, it is possible to suppress the occurrence of the access to the tape device 5 and to shorten the time period of responding.

At this time, by referring to the tape OBJ managing DB 43, the co-occurrence relation detecting unit 44 may detect, as (a candidate for) the second data, the OBJ whose read-time has the time difference within the predetermined time length from the read-time of the read-target OBJ.

In addition, by referring to the tape OBJ managing DB 43, the read-executing unit 47 may detect, as (a candidate for) the second data, the OBJ whose recording position in the PVs 5c is within the range having both ends defined by the recording positions of the multiple read-target OBJs in the data recording order in the PVs 5c.

Further, by referring to the tape OBJ managing DB 43, the read-executing unit 47 may store the read-target OBJ and the multiple OBJs as the multiple second data in the cache unit 42 after reading those OBJs from the PVs 5c, in an order based on the data recording order in the PVs 5c.

According to the above, it is possible to efficiently (e.g., rapidly) read the OBJs having the co-occurrence relation to the read-target OBJ from the PVs 5c to the cache unit 42, and to realize both a reduction in the processing load in the tiered storage apparatus 2 and suppression of an increase in the time period for responding with the read-target OBJ.

When the read-target OBJ exists in the cache unit 42, in response to a request from the read/write-request controlling unit 41 or the read-executing unit 47, the read-result replying unit 48 transmits the read-target OBJ to the APP 6a as a response (read-result) to the read-request.

In other words, when the second read-request to the PVs 5c, which regards the above-described second data as the read-target, is generated, the read-result replying unit 48 may transmit the second data to the transmission source of the second read-request, for example, the APP 6a after reading the second data stored in the cache unit 42.

As described above, in the system 1 according to the one embodiment, the OBJ having the co-occurrence relation to the read-target OBJ in the read-request is stored in the cache unit 42. Thus, in a case of receiving the read-requests for the multiple OBJs having the co-occurrence relation and being stored in the PVs 5c, even if the reading order does not coincide with the recording direction of the tapes of the PVs 5c, it is possible to read the OBJs from the cache unit 42 to respond. This can suppress an increase in the time period of reading.

In addition, since the read-OBJ optimizing unit 46 and the read-executing unit 47 read the OBJs having the co-occurrence relation from the PVs 5c along the recording direction of the tapes, it is possible to shorten the time period of reading. For example, it is assumed that the read-requests for relatively small OBJs each having a size from several KB to several tens of MB are generated in the order different from the recording direction of the tapes. In this case, by using the scheme according to the one embodiment, the tiered storage apparatus 2 can read the OBJs from the PVs 5c in the duration (period) two or more times shorter than (in the duration less than ½ of) the duration for reading in original order (i.e., the order of receiving the read-requests).

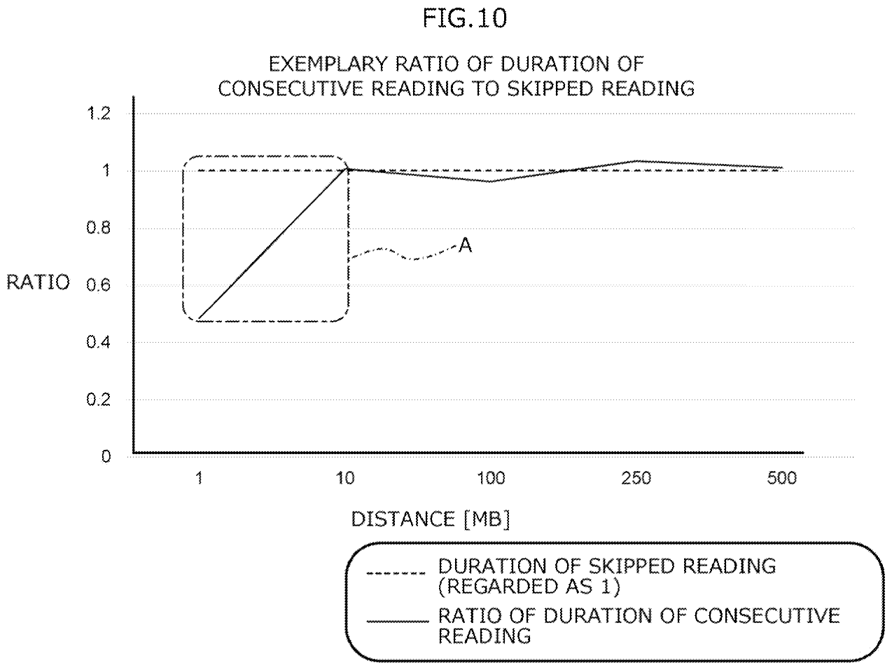

FIG. 10 is a diagram illustrating an exemplary ratio of duration (time period) of a consecutive reading to a skipped reading in the tapes. In a graph of FIG. 10, a horizontal axis represents distance (MB) and a vertical axis represents the ratio of the duration for which the consecutive reading is performed to the duration (regarded as “1”) for which the skipped reading is performed. FIG. 10 illustrates a measurement example of the duration for reading two OBJs of 1 MB each in the recording direction of the tape.

In FIG. 10, a broken line indicates the duration for reading a subsequent OBJ of 1 MB by skipping one OBJ of 1 MB. A solid line indicates the ratio of the duration for consecutively reading the OBJs of 1 MB without skipping to the duration for reading the subsequent OBJ of 1 MB by skipping the one OBJ of 1 MB.

As illustrated in FIG. 10, the skipped reading consumes a period of time related to the location of the positions to be read from the tapes of PVs 5c in the tape device 5. Thus, for example, as in a region indicated by a chain line denoted by a symbol A, the time period of reading becomes shorter (the reading becomes faster) in the consecutive reading than in the skipped reading. For example, in a case where the tiered storage apparatus 2 receives the read-requests for several dozen OBJs, the time period of reading is shortened by 20 times or more. Further, under a circumstance where the order of receiving the read-requests is different from the recording order in the tape, the reading in the order of the reception causes the location process, but the scheme according to the one embodiment can suppress the occurrence of the location process, and thus, can further shorten the time period of reading by several to several tens of times.

### <1-2> Operation Example

Next, an operation example of the system 1 according to the one embodiment will be described.

<1-2-1> Operation Example of Read-Time Managing Process and Transfer Instructing Process:

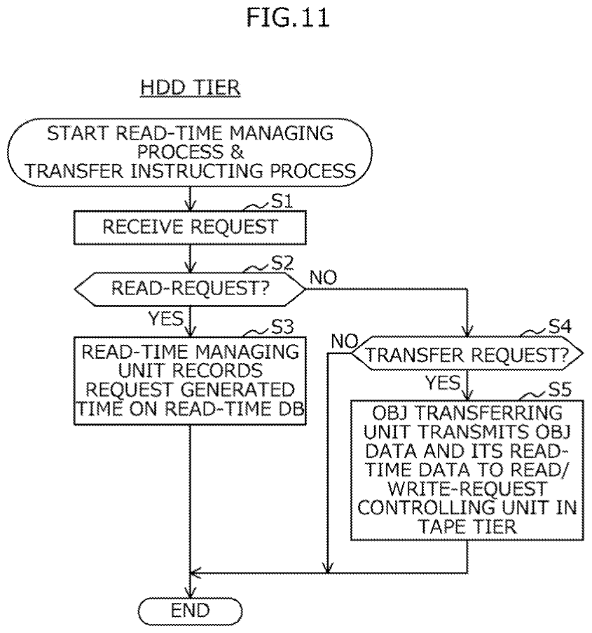

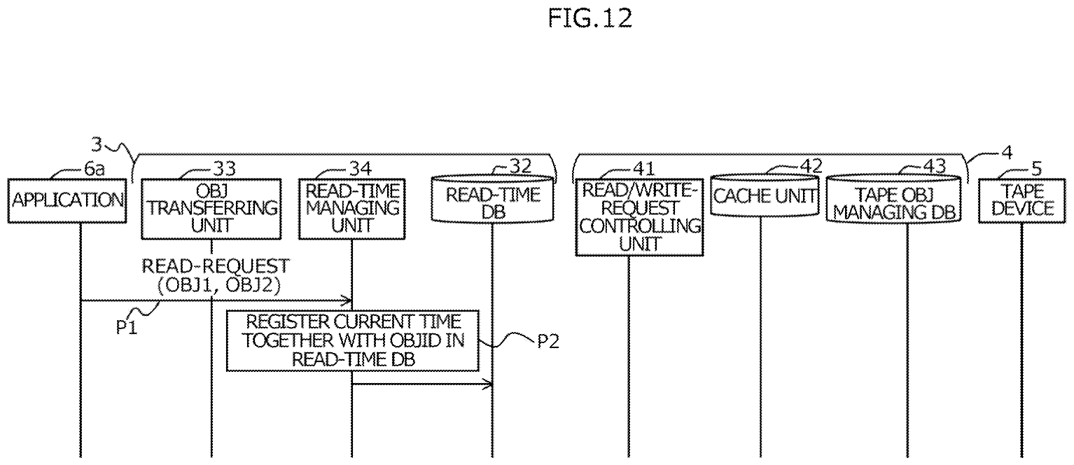

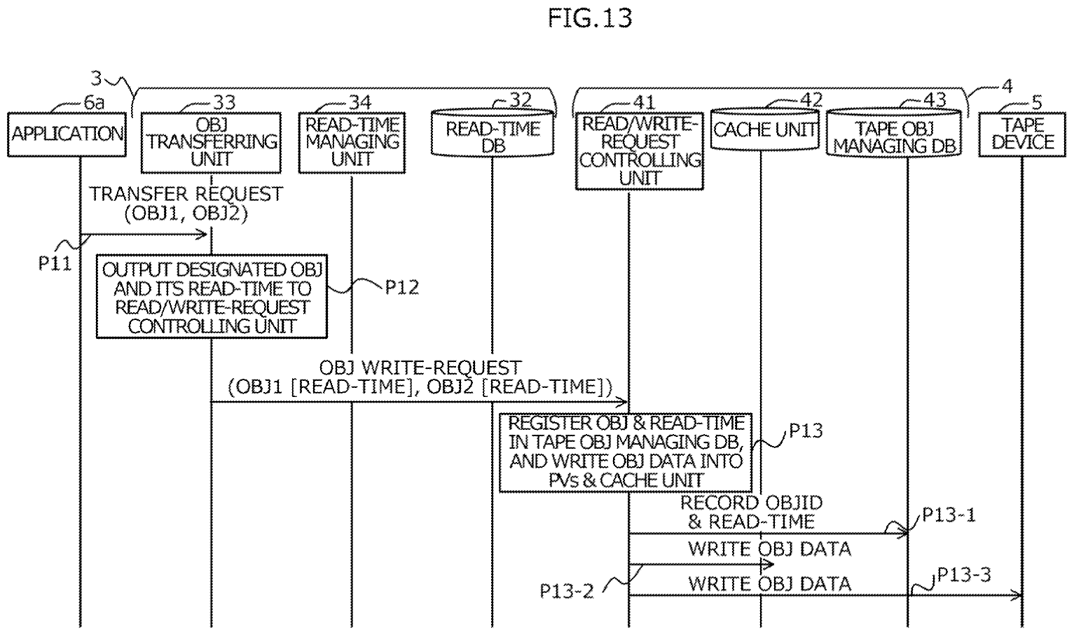

First, with reference to FIGS. 11 to 13, description will be made in relation to an operation example of the read-time managing process and the transfer instructing process by the HDD tier 3 and the tape tier 4. FIG. 11 is a flowchart for explaining an operation example of the read-time managing process and the transfer instructing process, FIG. 12 is a sequence diagram for explaining an example of the read-time managing process, and FIG. 13 is a sequence diagram for explaining an example of the transfer instructing process and a writing process.

As illustrated in FIG. 11, when receiving a request addressed to the HDD tier 3 from the APP 6a (Step S1), the HDD tier 3 of the tiered storage apparatus 2 determines whether or not the request is a read-request (Step S2).

If the request is a read-request (YES in Step S2; Process P1 in FIG. 12), the read-time managing unit 34 records the read-request generated time together with the OBJID on the read-time DB 32 (Step S3; Process P2 in FIG. 12), and the process ends.

If the received request is not a read-request (NO in Step S2), the request is determined whether or not a transfer-request (Step S4). When the request is a transfer-request (YES in Step S4; Process P11 in FIG. 13), the OBJ transferring unit 33 transmits the data on the OBJ and the read-time of the OBJ as a write-request to the read/write-request controlling unit 41 of the tape tier 4 (Step S5; Process P12 in FIG. 13), and the process ends. Process P13 (P13-1 to P13-3) in FIG. 13 will be described later.

If the received request is not a transfer-request (NO in Step S4), the request is, for example, a write-request. In this case, the HDD tier 3 may perform a process according to the write-request. As for the process according to the write-request in the HDD tier 3, various known schemes may be used, and thus, description thereof is omitted.

<1-2-2> Operation Example of Writing Process and Reading Process:

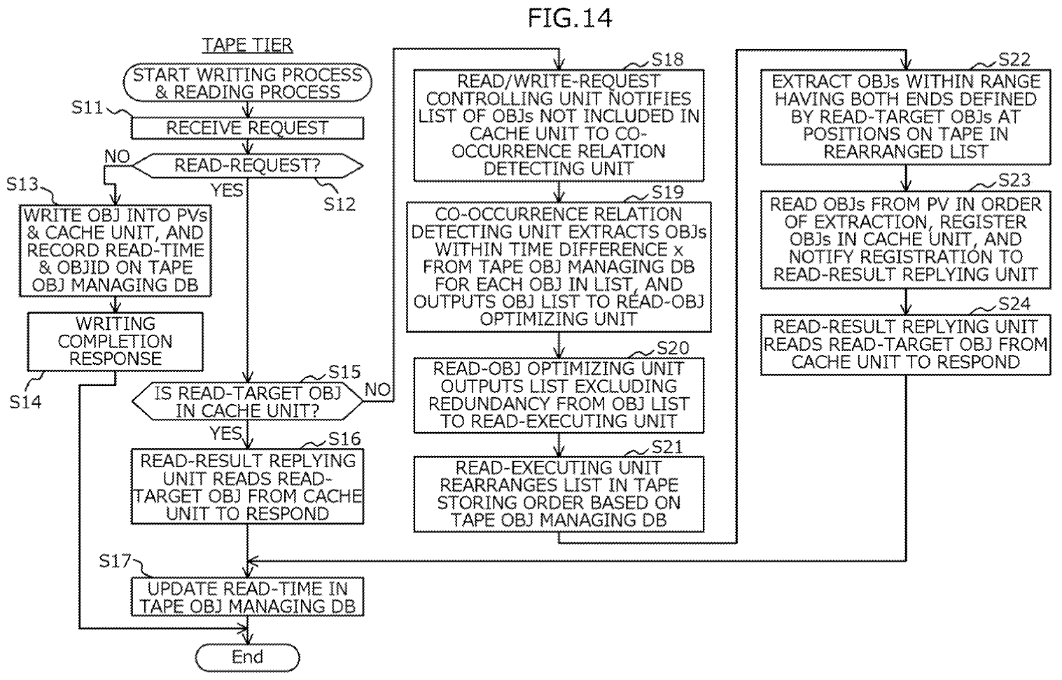

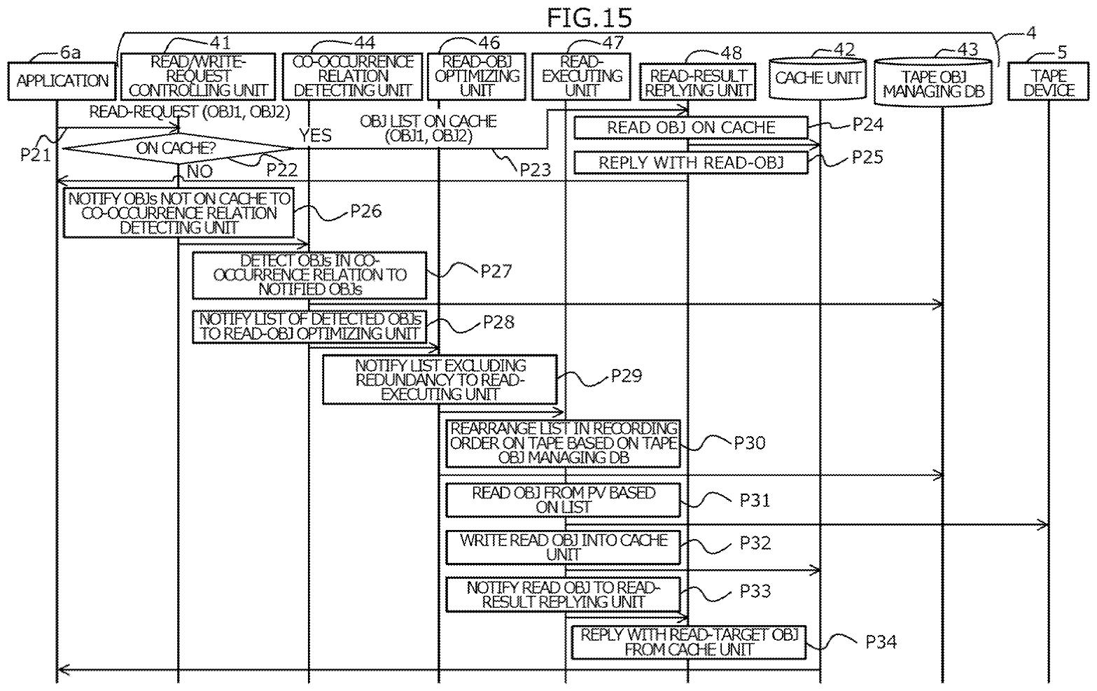

Next, with reference to FIG. 13 (Process P13), FIG. 14, and FIG. 15, description will be made in relation to an operation example of the writing process and the reading process by the tape tier 4. FIG. 14 is a flowchart for explaining an operation example of the writing process and the reading process, and FIG. 15 is a sequence diagram for explaining an example of the reading process.

As illustrated in FIG. 14, when receiving a request addressed to the tape tier 4 from the APP 6a or the HDD tier 3 (Step S11), the tape tier 4 of the tiered storage apparatus 2 determines whether or not the request is a read-request (Step S12).

If the request is not a read-request (NO in Step S12), for example, if the request is a write-request (transfer-request) from the HDD tier 3 (Process P12 in FIG. 13), the read/write-request controlling unit 41 acquires the OBJ of the write-target (transfer-target) and the read-time from the HDD tier 3. For example, the read/write-request controlling unit 41 writes the data of the OBJ of the write-target into both the PVs 5c and the cache unit 42, and records the OBJID and the read-time of the OBJ of the write-target on the tape-OBJ managing DB 43 (Step S13; Process P13, P13-1 to P13-3 in FIG. 13). Then, the read/write-request controlling unit 41 transmits a writing completion response to the HDD tier 3 (Step S14), and the process ends.

When the received request is a read-request (YES in Step S12; Process P21 in FIG. 15), the read/write-request controlling unit 41 determines whether or not the read-target OBJ exists in the cache unit 42 (Step S15; Process P22 in FIG. 15).

If the read-target OBJ exists in the cache unit 42 (YES in Step S15; YES in Process P22 of FIG. 15), the read/write-request controlling unit 41 transmits a list of the read-target OBJs existing in the cache unit 42 to the read-result replying unit 48 (Process P23 in FIG. 15).

The read-result replying unit 48 reads the read-target OBJ from the cache unit 42 on the basis of the list of the read-target OBJs existing in the cache unit 42 (Process P24 in FIG. 15). The read-result replying unit 48 transmits (responds with) the read OBJ as a read-result to the transmission source of the request (for example, the APP 6a) (Step S16; Process P25 in FIG. 15).

Further, the read/write-request controlling unit 41 updates the read-time in the tape OBJ managing DB 43 for the read-target OBJ in the received read-request (Step S17), and the process ends.

On the other hand, when the read-target OBJ does not exist in the cache unit 42 (NO in Step S15; NO in Process P22 of FIG. 15), the read/write-request controlling unit 41 refers to the cache unit 42 and acquires (generates) a list of the read-target OBJs not existing in the cache unit 42. The read/write-request controlling unit 41 notifies the list to the co-occurrence relation detecting unit 44 (Step S18; Process P26 in FIG. 15).

The co-occurrence relation detecting unit 44 detects OBJs having the co-occurrence relation to the OBJs in the notified list (Process P27 in FIG. 15). For example, the co-occurrence relation detecting unit 44 extracts, from the tape OBJ managing DB 43, the OBJs within the time difference x for each OBJ in the list to generate the OBJ list 45. Then, the co-occurrence relation detecting unit 44 outputs the OBJ list 45 to the read-OBJ optimizing unit 46 (Step S19; Process P28 in FIG. 15).

The read-OBJ optimizing unit 46 outputs a list excluding the redundancy from the OBJ list 45 to the read-executing unit 47 (Step S20; Process P29 in FIG. 15).

The read-executing unit 47 rearranges the OBJs in the list in the recording order on the tapes of the PVs 5c on the basis of the tape OBJ managing DB 43 so as to suppress the execution of the location process (Step S21; Process P30 in FIG. 15).

The read-executing unit 47 extracts the OBJs within the range having both ends defined by the read-target OBJs at the positions on the tape in the rearranged list (Step S22). Then, the read-executing unit 47 reads the OBJs from the PVs 5c in the order of extracting the OBJs (Process P31 in FIG. 15), and writes (registers) the read OBJs into the cache unit 42 (Process P32 in FIG. 15).

The read-executing unit 47 notifies the read-result replying unit 48 that the OBJs have been read from the PVs 5c to the cache unit 42 (Step S23; Process P33 in FIG. 15).

The read-result replying unit 48 reads the read-target OBJ from the cache unit 42, transmits (responds with) the read-target OBJ as a read-result to the transmission source (e.g., the APP 6a) of the request (Step S24; Process P34 in FIG. 15), and the process proceeds to Step S17.

### <2> Miscellaneous

The technique according to the one embodiment described above can be changed or modified as follows.

For example, the functional blocks of the tiered storage apparatus 2 illustrated in FIG. 4 may be merged in any combination, or may each be divided.

The tiered storage apparatus 2 according to the one embodiment may be, for example, a Virtual Machine (VM) or a physical machine. The functions of the HDD tier 3 and the tape tier 4 may be realized by one computer 2a or by two or more computers 2a. Further, at least some of the functions of the HDD tier 3 and the tape tier 4 may be implemented by using HW resources and Network (NW) resources provided by cloud environments.

In one aspect, it is possible to suppress an increase in time period for reading multiple data stored in a portable recording medium.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A control apparatus that controls access to a recording medium recording a plurality of data, the control apparatus comprising:
a memory; and
a processor coupled to the memory,
the processor being configured to
store a first data and a second data in a storing region after reading each of the first data and the second data from the recording medium based on first information including information on respective recording positions of the plurality of data in the recording medium and respective read-times at which the plurality of data are read from the recording medium, the first data serving as a read-target of a first read-request to the recording medium, the second data having co-occurrence relation to the first data, and
transmit, in a case where a second read-request to the recording medium is detected, the second data to a transmission source of the second read-request after reading the second data stored in the storing region, the second read-request regarding the second data as a read-target.

2. The control apparatus according to claim 1, wherein the processor detects, as the second data, data whose read-time has a time difference within a predetermined time length from the read-time of the first data, by referring to the first information when storing the second data.

3. The control apparatus according to claim 2, wherein the processor
receives a plurality of the first read-requests that regard a plurality of the first data different from each other as read-targets, and
detects, as the second data, data whose recording position in the recording medium is within a range having both ends defined by recording positions of the plurality of the first data in a data recording order in the recording medium, by referring to the first information when storing the second data.

4. The control apparatus according to claim 2, wherein the processor stores the first data and a plurality of the second data in the storing region after reading the first data and the plurality of the second data from the recording medium in an order based on a data recording order in the recording medium, by referring to the first information when storing the first data and the second data.

5. The control apparatus according to claim 1, wherein the processor transmits the first data to a transmission source of the first read-request after reading the first data stored in the storing region.

6. The control apparatus according to claim 1, wherein the processor
stores the plurality of data in a storing device having an access speed higher than an access speed of the recording medium, and
when a transfer-request for the plurality of data from the storing device to the recording medium is detected, stores the plurality of data in the recording medium and records, on the first information, respective read-times of the plurality of data in the storing device as initial values of the respective read-times of the plurality of data in the recording medium.

7. A method for reading data performed by a computer that controls access to a recording medium recording a plurality of data, the method comprising:
storing a first data and a second data in a storing region after reading each of the first data and the second data from the recording medium based on first information including information on respective recording positions of the plurality of data in the recording medium and respective read-times at which the plurality of data are read from the recording medium, the first data serving as a read-target of a first read-request to the recording medium, the second data having co-occurrence relation to the first data, and
transmitting, in a case where a second read-request to the recording medium is detected, the second data to a transmission source of the second read-request after reading the second data stored in the storing region, the second read-request regarding the second data as a read-target.

8. The method according to claim 7, wherein the storing comprises detecting, as the second data, data whose read-time has a time difference within a predetermined time length from the read-time of the first data, by referring to the first information.

9. The method according to claim 8, further comprising receiving a plurality of the first read-requests that regard a plurality of the first data different from each other as read-targets, wherein
the storing comprises detecting, as the second data, data whose recording position in the recording medium is within a range having both ends defined by recording positions of the plurality of the first data in a data recording order in the recording medium, by referring to the first information.

10. The method according to claim 8, wherein the storing comprises storing the first data and a plurality of the second data in the storing region after reading the first data and the plurality of the second data from the recording medium in an order based on a data recording order in the recording medium, by referring to the first information.

11. The method according to claim 7, further comprising transmitting the first data to a transmission source of the first read-request after reading the first data stored in the storing region.

12. The method according to claim 7, further comprising:
storing the plurality of data in a storing device having an access speed higher than an access speed of the recording medium; and
when a transfer-request for the plurality of data from the storing device to the recording medium is detected, storing the plurality of data in the recording medium and recording, on the first information, respective read-times of the plurality of data in the storing device as initial values of the respective read-times of the plurality of data in the recording medium.
